(19) United States
(12) Patent Application Publication
(10) Pub. No.: US 2015/0273399 A1
(43) Pub. Date: Oct. 1, 2015

(54) SYSTEMS AND METHODS FOR FABRICATION OF FORWARD OSMOSIS MEMBRANES USING ROLL-TO-ROLL PROCESSING

(71) Applicant: PORIFERA, INC., Hayward,, CA (US)

(72) Inventors: Il-Juhn Roh, San Ramon, CA (US); Ravindra Ravanur, Fremont, CA (US); Aleksandr Noy, San Carlos, CA (US); Olgica Bakajin, San Leandro, CA (US)

(21) Appl. No.: 14/440,254

(22) PCT Filed: Nov. 1, 2013
(86) PCT No.: PCT/US2013/068143

§ 371 Date: May 1, 2015

Related U.S. Application Data
(60) Provisional application No. 61/721,867, filed on Nov. 2, 2012.

(51) Int. Cl. B01D 67/00; B01D 61/00; B01D 69/12; B05D 3/10

(52) U.S. Cl. CPC B01D 67/0002; B05D 3/107; B01D 61/002; B01D 69/12

(57) ABSTRACT

Examples are described including membrane fabrication systems using roll-to-roll processing to fabricate a forward osmosis membrane. Fabric supported by a solid sheet may be cast with a polymer and a selectivity layer may be applied to form the forward osmosis membrane. The forward osmosis membrane supported by the solid sheet may be delaminated using an alcohol.

### CROSS-REFERENCE

This application claims the benefit of the earlier filing date of U.S. Provisional Application No. 61/721,867, filed Nov. 2, 2012, which application is incorporated herein by reference, in its entirety, for any purpose.

### GOVERNMENT SPONSORSHIP

This invention was made with Government support under contract number W911NF-09-C-0079 awarded by the Department of Defense. The Government has certain rights in this invention.

### TECHNICAL FIELD

Examples described herein relate to systems and methods for fabricating forward osmosis membranes, including systems and methods using roll-to-roll processing.

### BACKGROUND

Membranes may be used to perform osmosis, which generally occurs when two solutions of differing concentration are placed on opposite sides of a permeable or semi-permeable membrane. Forward osmosis is a process where water flows through a permeable or semi-permeable membrane from a solution with relatively low salt concentration (e.g. feed solution) to a solution with relatively high salt concentration (e.g. draw solution). The generated osmotic pressure difference drives the permeation of water across the membrane from the dilute solution to the concentrated solution, while the selective property of the membrane retains the solutes in their respective solution.

Performance of a thin film composite (TFC) forward osmosis membrane is often linked to the structural properties of the membrane. A TFC membrane is a membrane that has layers of materials (e.g. dissimilar materials) joined together to form a single membrane. This layered construction permits the use of material combinations that optimize performance and durability of the membrane. TFC membranes may include a support layer and a selectivity layer. Forward osmosis membranes can incorporate fragile fabrics that are challenging to use in a roll to roll manufacturing process.

### SUMMARY

Examples of systems and methods for fabrication of a forward osmosis membrane are disclosed herein. For example, a first roller system may be positioned to transport a solid sheet through a casting region and a phase inversion bath. In some examples, a second roller system may be positioned to transport the solid sheet through any of an interfacial polymerization region and an alcohol separation bath. In some examples, the solid sheet may be formed from a polyolefin.

A casting region may include a chamber housing a casting solution, and may release the casting solution to cast polymer. In some examples, a polymer solution infiltrated matrix may be formed by casting polymer solution on a fabric supported by a solid sheet. In some examples, a polymer solution infiltrated matrix may be formed by casting polymer on a solid sheet and then applying a fabric to the cast solid sheet.

A phase inversion bath may house a nonsolvent coagulation agent. The polymer solution infiltrated matrix may be immersed into the phase inversion bath to form a support membrane. In some examples, the support membrane may be a forward osmosis membrane.

An interfacial polymerization region may include a path through an aqueous solution, an organic solution, and an oven housed therein. In some examples, a selectivity layer may be formed on the support membrane in the interfacial polymerization region to form a forward osmosis membrane. In some examples, the selectivity layer may be a polyamide layer. In some examples, the selectivity layer may be formed on a side of the support membrane previously in contact with the solid sheet. In some examples, the selectivity layer may be formed on a side of the support membrane opposite of the solid sheet.

An alcohol separation bath may house an alcohol. The forward osmosis membrane may be delaminated from the solid sheet by treating the forward osmosis membrane with the alcohol. In some examples, a delaminating element positioned proximate to the alcohol separation bath may be used to separate the forward osmosis membrane and the solid sheet.

### BRIEF DESCRIPTION OF THE DRAWINGS

FIG. 1 is a schematic illustration of a membrane fabrication system arranged in accordance with embodiments of the present invention.

FIG. 2 is a schematic illustration of a portion of the membrane fabrication system shown in FIG. 1 arranged in accordance with embodiments of the present invention.

FIG. 3 is a schematic illustration of a portion of the membrane fabrication system shown in FIG. 1 arranged in accordance with embodiments of the present invention.

FIG. 4 is a cross-sectional schematic illustration of a supported forward osmosis membrane arranged in accordance with embodiments of the present invention.

FIG. 5 is a schematic illustration of a portion of the membrane fabrication system shown in FIG. 1 arranged in accordance with embodiments of the present invention.

FIG. 6 is a schematic illustration of a portion of a membrane fabrication system arranged in accordance with embodiments of the present invention.

### DETAILED DESCRIPTION

Certain details are set forth below to provide a sufficient understanding of embodiments of the invention. However, it will be clear to one skilled in the art that embodiments of the invention may be practiced without certain ones of these particular details. In some instances, well-known chemical structures, chemical components, molecules, materials, manufacturing components, control systems, electronic components, timing protocols, and software operations have not been shown in detail in order to avoid unnecessarily obscuring the described embodiments of the invention.

Disclosed herein are example embodiments of systems, apparatuses and methods for fabricating forward osmosis membranes. Examples described include scalable mechanisms for conducting roll-to-roll processing to produce forward osmosis membranes with specific structural properties that may be optimized for performance and durability. Forward osmosis membranes disclosed herein may include thin film composite (TFC) structures that may include a support layer that may support a selectivity layer that may enhance the membrane rejection performance. As mentioned above, the performance of forward osmosis membranes is generally linked to its structural properties. Accordingly, examples described herein may provide scalable systems and methods to fabricate and handle forward osmosis membranes quickly, accurately, and at a relatively low cost.

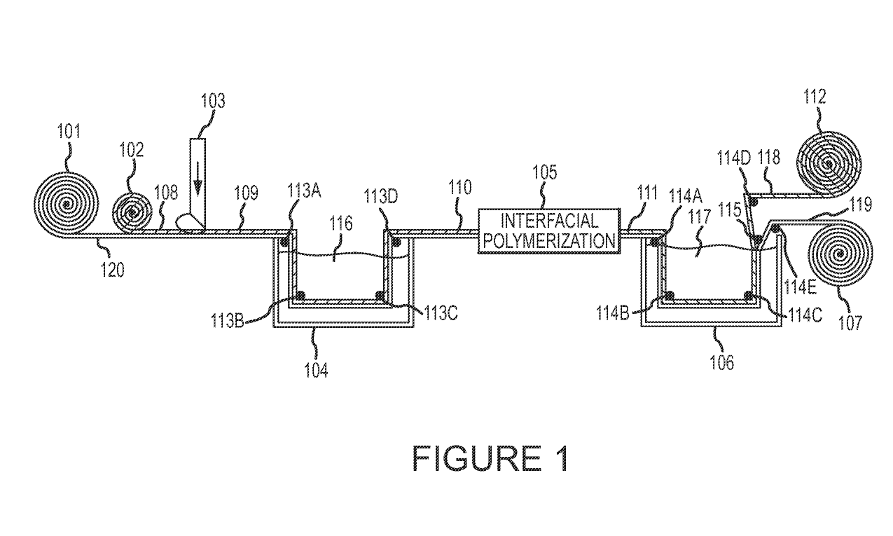

FIG. 1 is a schematic illustration of a membrane fabrication system, according to one or more embodiments. The membrane fabrication system may include a solid sheet feed roll 101 that may unroll during operation to transfer a solid sheet 120 to a casting region 103 of the membrane fabrication system. The solid sheet feed roll 101 may be a roll wound with a support material that may not disadvantageously react with downstream processes in the membrane fabrication system. In some examples, the solid sheet 120 may be a polyolefin, such as polyethylene, or polypropylene, or combinations thereof. It may be advantageous to use polyolefins due to their high mechanical strength, solvent resistance, and high heat stability in some examples. These properties of polyolefins may allow the forward osmosis membrane formed by the membrane fabrication system to withstand rigors associated with the fabrication process. For example a preferably high tension that may reduce or eliminate wrinkling and may allow machines to operate at higher speeds and lower cost. Additionally, these properties of polyolefins may facilitate delamination of the support or forward osmosis membrane from the support, drying prevention and tight selectivity layer formation and prevention of double selectivity layer formation in some examples.

The membrane fabrication system may also include a fabric feed roll 102 positioned either upstream or downstream with respect to the casting region 103. In some examples, the fabric feed roll 102 may be positioned upstream from the casting region 103, and may unroll during operation to transfer fabric to be supported by (e.g. contact) the solid sheet 120 being transferred to the casting region 103. In some examples, the fabric feed roll 102 may be positioned downstream from the casting region 103, and may unroll to transfer fabric to be supported by (e.g. contact) a cast solid sheet being transferred from the casting region 103 to a phase inversion bath 104. The fabric feed roll 102 may be a roll wound with a fabric. The material for the fabric may be chosen based on desired properties, for example porosity and thickness. In some examples, the fabric may be made from polyester, polyamide, or combinations thereof. The thickness of the fabric may be in the range of 15-150 gm in some examples, 20-100 gm in some examples, and 30-80 gm thick in some examples. The porosity of the fabric may be in the range of 20-80% in some examples and 30-70% in some examples. The fabric may be woven or nonwoven. The density for the nonwoven fabric may be in the range of 5-60 g/sq meter in some examples and 5-50 g/sq meter in some examples. The woven fabric may have a mesh count in the range of 20-200 number/cm in some examples, 30-180 number/cm in some examples, and 30-150 number/cm in some examples.

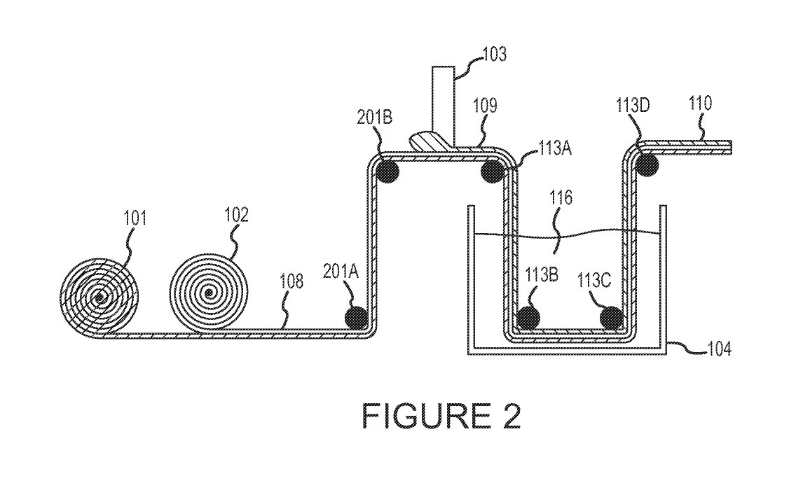

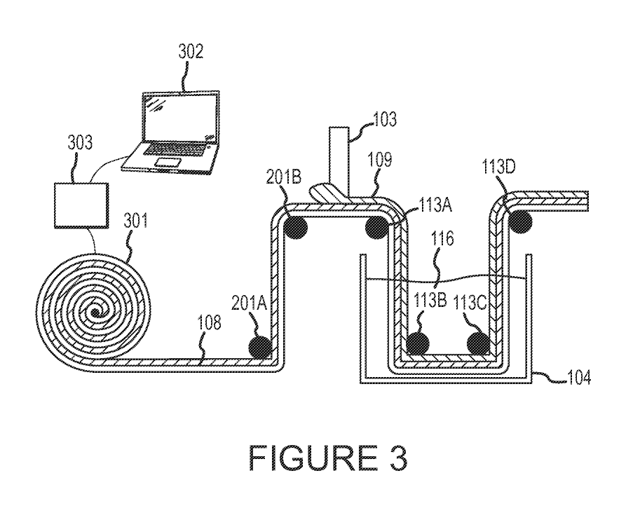

FIG. 2 is a schematic illustration of a portion of the membrane fabrication system shown in FIG. 1, according to one or more embodiments. A fabric supported by a solid sheet (referred to herein as supported fabric 108) may be transferred to the casting region 103 by a feed rolling system 201A-201B. The feed rolling system 201A-201B may include one or more rollers that may couple with the supported fabric 108 and may spin so as to transfer it to the casting region 103. The one or more rollers of the feed rolling system 201A-201B may be arranged to transfer the supported fabric 108 along a predefined path. The one or more rollers of the feed rolling system 201A-201B may include features, for example a pattern of grooves, to couple with the solid sheet. In some examples, the one or more rollers of the feed rolling system 201A-201B may transport the supported fabric 108 while providing a constant tension on the unwinding solid sheet roll 101 and fabric feed roll 102. In some examples, the one or more rollers of the feed rolling system 201A-201B may be arranged so as to minimize excessive stresses while transporting the solid sheet. In some examples, one or more of the rollers of the feed rolling system 201A-201B may be coupled with one or more motors 303 that may spin one or more of the rollers in a predefined manner. The one or more motors 303 may be coupled to a controller 302 (an example shown in FIG. 3), which may receive user input, such as spin speed. The controller 302 may be an electronic device, for example a computing device, that may transmit control signals at predefined times and/or predefined intervals to the one or more motors 303 of the feed rolling system 201A-201B. In some examples, a single controller may be used to control the feed rolling system 201A-201B, a roller system 113A-113D, and the secondary roller system 114A-114D. In some examples, the controller 302 may control a take up roller via a motor coupled to the take up roller. The take up roller may be positioned downstream from all the rollers of the membrane fabrication system. In some examples, the take up roller may be the only roller coupled to a motor, and may provide the driving force for transporting the solid sheet through the membrane fabrication system.

The casting region 103 may be positioned at any point downstream from the solid sheet feed roll 101 and upstream from a phase inversion bath 104. In some examples, as shown in FIG. 2, the casting region 103 may be positioned downstream from the solid sheet and the fabric have been unrolled and coupled to one another. The casting region 103 may include a chamber housing a casting solution. The casting solution may include aramid polymers, such as meta-aramids and mixtures of meta-aramids (e.g., NOMEX®) and para-aramids (e.g., KEVLAR®). Other options for the casting solution may include acrylate-modified poly(vinylidene fluoride) polymers. The casting solution may have a concentration of polymer in the range of 5-20 wt % in some examples. In other examples, other concentrations may be used.

Meta-aramid or similar support materials may offer several advantages over state-of-the-art materials (such as polysulfone) in some examples. Possible advantages include (1) improved membrane formability and flexibility, (2) enhanced chemical resistance, (3) enhanced structural stability, (4) hydrophilicity, which could result in enhanced anti-fouling properties, and enhanced flux through the membrane in several types of applications (e.g. forward osmosis). These advantages are provided herein by way of illustration and to aid in understanding. It is to be understood that not all examples provide all advantages, and indeed some examples of the present invention may not provide any of the described advantages.

The meta-aramid polymer support layer also may incorporate functionalized or unfunctionalized carbon nanotubes to enhance the membrane performance. In some examples, the casting solution may be provided in a solvent. The solvent may be polar, and may include N-methyl-2-pyrrolidone (NMP), N,N-dimethylacetamide (DMAc), N,N-dimethylformamide (DMF), dimethyl sulfoxide (DMSO), or combinations thereof. The solvent may be combined with a salt, for example LiCl. In some examples, the casting solution may be formed by dissolving NOMEX® in DMAc-LiCl salt solution at 100° C. under constant stirring for 4 hours.

The chamber housing the casting solution may be shaped to hold a desired amount of casting solution. The chamber may be coupled to a release element, for example a casting knife or slot die that may release the casting solution at a desired rate over a desired release area. In some examples, the control element may be a barrier provided by a casting knife that allows only a certain thickness to pass through. In some examples, the control element may regulate the amount of casting solution to pass through by other known methods. In some examples, the release element may release the casting solution on to the solid sheet 120 or the supported fabric 108. The solid sheet 120 may be treated with solvent to improve wetting of the casting solution. Releasing the casting solution on to the solid sheet or the fabric supported by the solid sheet generally results in the polymer of the casting solution to be cast to form a polymer solution infiltrated matrix 109. The cast polymer may integrate with the fabric (e.g. be disposed within the fabric). The polymer solution infiltrated matrix 109 may then be transported to a phase inversion bath 104 where phase separation occurred and the solvent and salt from the casting solution may be removed.

FIG. 3 is a schematic illustration of a portion of the membrane fabrication system shown in FIG. 1, according to one or more embodiments. In some examples, the solid sheet and the fabric may be rolled in a combined feed roll 301. The combined feed roll 301 may be arranged such that it may be unrolled to feed the casting region 103 with the supported fabric 108. In some examples, the combined feed roll 301 may be unrolled such that the fabric may be positioned with the fabric facing up to to receive the casting solution. The supported fabric 108 may pass through the casting region 103 to be cast with polymer to form a polymer solution infiltrated matrix 109 and then transported to the phase inversion bath 104, as described above. It may be advantageous to use the combined roll 301 in some examples to reduce complexity of the membrane fabrication system and to improve the rate at which the forward osmosis membrane may be fabricated.

The phase inversion bath 104 may receive the polymer solution infiltrated matrix 109 and may perform a phase inversion process to form a support membrane 110. The phase inversion 104 bath may house a number of nonsolvent-solvent mixtures, for example a nonsolvent coagulation agent 116. Different solvent-additive-nonsolvent mixtures may be used, such as N-methylpyrrolidone (NMP)—tetrahydrofuran—water, NMP—chloroform—water and NMP -isopropanol—water, or combinations thereof. In some examples, the phase inversion bath 104 may house water. Contact between the polymer solution infiltrated matrix 109 and the nonsolvent coagulation agent 116 may trigger a solvent exchange resulting in a precipitation of the polymer solution infiltrated matrix whereby the support membrane 110 may be formed. During phase inversion, the solvent and salt of the polymer solution infiltrated matrix 110 may be removed, leaving only the cast polymer with fabric embedded. In some examples, the polymer solution infiltrated matrix 109 may be immersed in a phase inversion bath 104 with a first chamber housing a nonsolvent coagulation agent 116 and then immersed in a second chamber housing a nonsolvent agent, for example water. The first chamber and the second chamber may be maintained at a predefined temperature, for example at 4-40° C., for a predefined time period, for example 1-60 minutes, or until the salts present in the polymer solution infiltrated matrix 109 are removed.

A roller system 113A-113D may be positioned inside or proximate to the phase inversion bath 104 to transport the solid sheet through the casting region 103 and the phase inversion bath 104. The roller system 113A-113D may include one or more rollers that couple to the solid sheet. The one or more rollers of the roller system 113A-113D may be arranged to transfer the supported fabric 108 along a predefined path. The rollers may include features, for example a pattern of grooves, to couple with the solid sheet. In some examples, the one or more rollers of the roller system 113A-113D may be arranged so as to minimize excessive stresses while transporting the solid sheet. One or more rollers of the roller system 113A-113D may be immersed within the phase inversion bath 104, whereby the polymer solution infiltrated matrix 109 is transported through the phase inversion bath, allowing the support membrane 110 to be formed, as described above. One or more rollers of the roller system 113A-113D may be positioned proximate to the phase inversion bath 104, such that the polymer solution infiltrated matrix 109 may be transported from the casting region 103 to the phase inversion bath 104, and such that the support membrane 110 may be transported to downstream processes, for example, an interfacial polymerization region 105. In some examples, one or more of the rollers of the roller system 113A-113D may be coupled with one or more motors 303 that may spin one or more of the rollers in a predefined manner. The one or more motors 303 may be coupled to a controller 302, which may receive user input, such as spin speed. The controller 302 may be an electronic device, for example a computing device, that may transmit control signals at predefined times and/or predefined intervals to the one or more motors 303 of the roller system 113A-113D.

The membrane fabrication system may include an interfacial polymerization region 105 that may apply a selectivity layer to the support membrane 110 to form a forward osmosis membrane supported by a solid sheet (referred to herein as a supported forward osmosis membrane 111). The interfacial polymerization region 105 may include an aqueous solution, an organic solution, and an oven. The aqueous solution agent may contain a di- or polyfunctional amine. The aqueous solution may include combinations of 1,3 phenylenediamine (MPDA) (e.g. 0-10%), DABA (diaminobenzoic acid) (e.g. 0-10%), triethylamine (TEA) (e.g. 0-10%), sodium dodecylbenzenesulfonate (SDBS) (e.g. 0-10%), and/or camphor-10-sulfonic acid (CSA) (e.g. 0-10%). The organic solution may contain 0-1% 1,3,5-trimesoyl chloride (TMC) and/or isophthaloyl chloride (IPC) in Isopar G, Isopar C, hexanes, heptane, octane, chloroform or other solvents. Application of the aqueous solution to the support membrane 110, followed by application of the organic solution, and curing in an oven (e.g. 20-150° C.) for 0-5 minutes in some examples may form a selectivity layer on the support membrane 110 as passes through the interfacial polymerization region 105, forming the supported forward osmosis membrane 111. In some examples, the selectivity layer may include a polyamide layer that may improve the rejection performance of the forward osmosis membrane.

In some examples, the selectivity layer may be applied after delaminating the support membrane from the solid sheet. It may be advantageous to delaminate the membrane from the solid sheet before applying the selectivity layer when it is desired to apply the selectivity layer to the side of the membrane that was previously coupled to the solid sheet or on both sides of the membrane. Delaminating the membrane from the solid sheet may be performed using an alcohol in some examples. Additionally, after delamination the membrane may be thoroughly washed with water to remove the alcohol.

A selectivity layer may or may not be required to implement a forward osmosis membrane. For example, in some examples the cast polymer and fabric may themselves have sufficient performance characteristics to serve as a forward osmosis membrane without adding a selectivity layer. Thus, it will be appreciated that a membrane fabrication system according to the examples disclosed herein may or may not include an interfacial polymerization region that applies a selectivity layer. In some examples, a support membrane may be transferred from a phase inversion bath to an alcohol separation bath to delaminate the forward osmosis membrane without a selectivity layer from the solid sheet. In some examples, the membrane without a selectivity layer may be referred to as an asymmetric membrane. After delamination the membrane may be thoroughly washed with water to remove the alcohol and wetted with a solution of glycerol (2-50%) for storage.

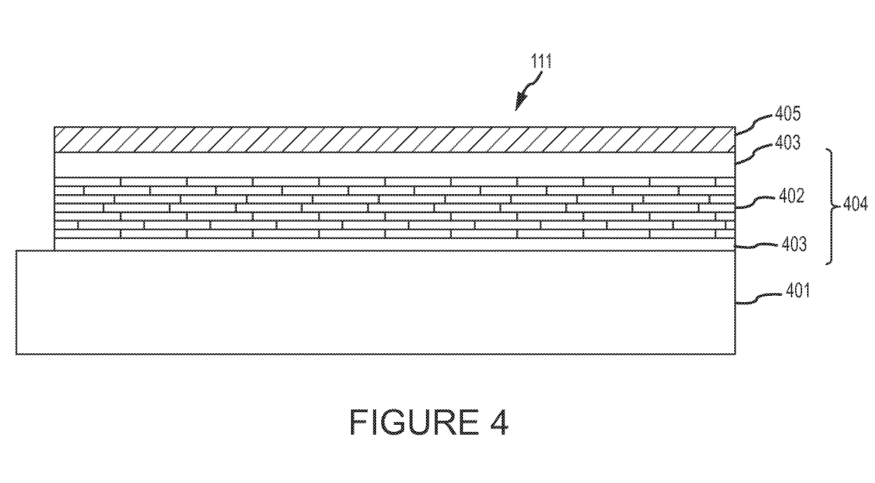

FIG. 4 is a cross-sectional schematic illustration of a supported forward osmosis membrane 111, according to one or more embodiments. The supported forward osmosis membrane 111 may include a solid sheet 401 that may support a cast polymer layer 404 and a selectivity layer 405. The thickness of the cast polymer layer 404 may vary between 10-150 microns (preferably 15-70 micron for a nonwoven fabric and 30-90 microns for a woven fabric). The thickness of the selectivity layer 405 may be preferably 50-500 nm. In some examples, the cast polymer layer 404 may include a cast polymer 403 and a fabric 402. In some examples, the viscosity of a casting solution used to cast the polymer of the cast polymer 403 may be relatively low and the fabric 402 may have a generally loose structure. Thus, when the casting solution is cast on to the fabric 402 supported by the solid sheet 401, it may penetrate the fabric 402 and, may reach to the bottom of the fabric 402 and to the surface of the solid sheet 401. After phase inversion, the fabric 402 may be integrated within the cast polymer 403 to form a matrix of a support membrane 110. Similarly, when the casting solution is cast directly on to the solid sheet 401 and the fabric 402 is transferred on top of it, the cast polymer 403 may integrate with the fabric 402 during phase inversion to form a matrix of a support membrane 110. After phase inversion, the support membrane 110 may undergo interfacial polymerization, in which the selectivity layer 405 may be applied to the support membrane 110 to form the supported forward osmosis membrane 111.

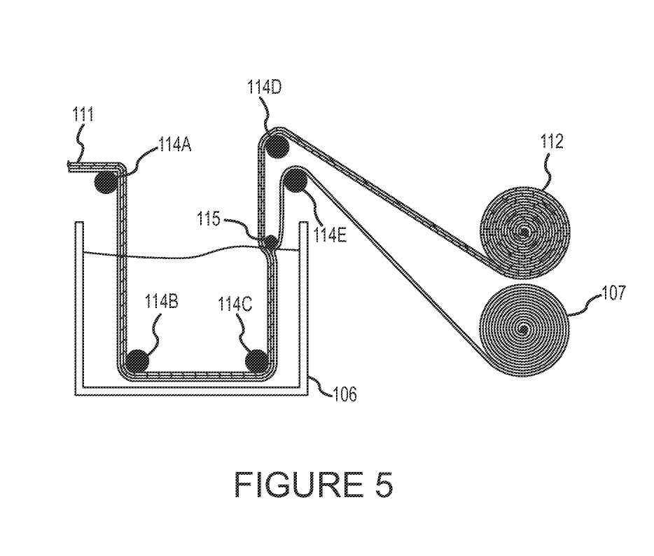

FIG. 5 is a cross-sectional schematic illustration of a portion of the membrane fabrication system of FIG. 1, according to one or more embodiments. The portion shown in FIG. 5 is a portion which may be used to delaminate a forward osmosis membrane from a solid sheet. The membrane fabrication system may include an alcohol separation bath 106, which may receive a supported forward osmosis membrane 111 and may delaminate the forward osmosis membrane from the solid sheet, e.g. the forward osmosis membrane 118 and the solid sheet 119 of FIG. 1. The alcohol separation bath 106 may house an alcohol 117, for example methyl alcohol, ethyl alcohol, propyl alcohol, isopropyl alcohol, butyl alcohol, or combinations thereof. In some examples, the alcohol 117 may be diluted in water to form an alcohol solution. When the supported forward osmosis membrane 111 is immersed in the alcohol 117 or the alcohol solution, the forward osmosis membrane 118 and the solid sheet 119 may delaminate. In some examples, the membrane may be rinsed with water to remove the alcohol, and may be treated with a preservative, such as glycerol before drying, for membrane storage.

Secondary roller system 114A-114D may be positioned inside or proximate to the alcohol separation bath 106 to transport the supported forward osmosis membrane 111 through the interfacial polymerization region 105 and alcohol separation bath 106. The secondary roller system 114A-114D may include one or more rollers that couple to the supported forward osmosis membrane 111. The one or more rollers of the secondary roller system 114A-114D may be arranged to transfer the supported forward osmosis membrane 111 along a predefined path. The rollers may include features, for example a pattern of grooves, to couple with the solid sheet. In some examples, the one or more rollers of the secondary roller system 114A-114D may be arranged so as to minimize excessive stresses while transporting the supported forward osmosis membrane 111. One or more rollers of the secondary roller system 114A-114D may be immersed within the alcohol separation bath 106, such that the supported forward osmosis membrane 111 is transported through the alcohol separation bath 106, allowing the forward osmosis membrane 118 to delaminate from the solid sheet 119, as described above. One or more rollers of the secondary roller system 114A-114D may be positioned proximate to the alcohol separation bath 106, such that the supported forward osmosis membrane 111 may be transported from the interfacial polymerization region 105 to the alcohol separation bath 106, and such that the delaminated forward osmosis membrane 118 and solid sheet 119 may be transported to downstream processes, for example, the delaminating element 115. In some examples, one or more of the rollers of the secondary roller system 114A-114D may be coupled with one or more motors 303 that may spin one or more of the rollers in a predefined manner. The one or more motors 303 may be coupled to a controller 302, which may receive user input, such as spin speed. The controller 302 may be an electronic device, for example a computing device, that may transmit control signals at predefined times and/or predefined intervals to the one or more motors 303 of the secondary roller system 114A-114D.

The delaminating element 115 may be positioned downstream relative to the alcohol bath 106. The delaminating element 115 may be used to decouple the solid sheet 119 and the forward osmosis membrane 118 after treatment of the supported forward osmosis membrane 111 in the alcohol bath 106. The delaminating element 115 may be positioned in the path crated by the secondary roller system 114A-114D such that the delaminated solid sheet 119 and forward osmosis membrane 118 may further separate and be directed to either a forward osmosis membrane roll 112 or a delaminated solid sheet roll. The delaminating element 115 may be shaped to facilitate directing the forward osmosis membrane 118 and the solid sheet 119 to the appropriate roll. In some examples, the delaminating element 115 may include a relatively narrow end facing upstream and a relatively wide end facing downstream. The forward osmosis membrane 118 and the solid sheet 119 may be transported to the delaminating element 115 after treatment in the alcohol bath 106, and the narrow end of the delaminating element may facilitate separation of the forward osmosis membrane 118 and the solid sheet 119. It will be understood by one skilled in the art that other mechanisms for directing a solid sheet in one direction and a forward osmosis membrane in a second direction may be used to effect a separation.

The forward osmosis membrane 118 may be wound on the forward osmosis membrane roll 112. The solid sheet 119 delaminated from the forward osmosis membrane 118 may be wound on the delaminated solid sheet roll 107. In some examples, the forward osmosis membrane 118 may be washed with water prior to winding. In some examples, the forward osmosis membrane 118 may be treated with a preservative, such as glycerol before drying, for membrane storage.

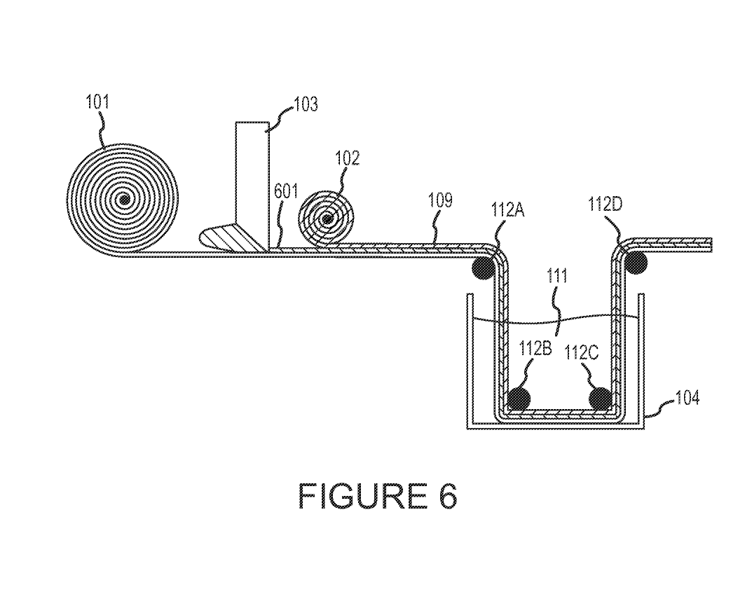

FIG. 6 is a cross-sectional schematic illustration of a portion of a membrane fabrication system, according to one or more embodiments. In some examples, the solid sheet may be cast with polymer before adding the fabric. This may be achieved by unrolling the solid sheet from the solid sheet feed roll 101 to the casting region 103, and releasing the casting solution directly on to the solid sheet forming a cast solid sheet 601. The solid sheet may be modified with solvent or hydrophilic coatings to improve wetting of the polymer solution. Once the solid sheet is cast with polymer, the control element may even out the distribution of the cast polymer across the cast solid sheet 601. The fabric feed roll 102 may be unrolled to transport woven or nonwoven fabric to the cast solid sheet 601, whereby the fabric may be at least partially embedded into the cast polymer of the cast solid sheet 601 to form a polymer solution infiltrated matrix 109. The extent to which the fabric is embedded into the cast polymer may depend on the viscosity of the casting solution, the porosity of the fabric, and by the time allowed for infiltration before phase inversion. The polymer solution infiltrated matrix 109 may undergo phase inversion, interfacial polymerization and delamination to form a forward osmosis membrane, as described above.

It may be advantageous in some examples to cast the polymer directly on to the solid sheet when a thinner layer of cast polymer is desired. A thinner layer of cast polymer may have a higher flux than a membrane of the same total thickness with a thicker layer of cast polymer because of reduced concentration polarization. In some examples, the layer of cast polymer may be separated from the solid sheet before interfacial polymerization.

From the foregoing it will be appreciated that, although specific embodiments of the invention have been described herein for purposes of illustration, various modifications may be made without deviating from the spirit and scope of the invention.

What is claimed is:

1. A method for fabrication of a forward osmosis membrane, the method comprising:
casting polymer solution on a fabric supported by a solid sheet to form a polymer solution infiltrated matrix; and
immersing the polymer solution infiltrated matrix into a phase inversion bath to form a membrane.

2. The method of claim 1, further comprising forming a selectivity layer on the support membrane using interfacial polymerization to form the forward osmosis membrane.

3. The method of claim 1, further comprising unrolling the fabric supported by a solid sheet and wherein said immersing the polymer solution infiltrated matrix into a phase inversion bath comprises rolling the polymer solution infiltrated matrix along a path through the phase inversion bath.

4. The method of claim 1, further comprising unrolling the solid sheet from a first roll and unrolling the fabric from a second roll such that the fabric becomes supported by the solid sheet.

5. The method of claim 2, wherein the selectivity layer is formed on a side of the support membrane opposite a side in contact with the solid sheet.

6. The method of claim 2, further comprising delaminating the support membrane from the solid sheet using an alcohol and wherein the selectivity layer is formed on a side of the support membrane opposite a side in contact with the solid sheet

7. The method of claim 1 further comprising feeding the solid sheet from a first roll and feeding the fabric from a second roll.

8. (canceled)

9. The method of claim 1, wherein the solid sheet is a film formed from a polyolefin.

10. (canceled)

11. (canceled)

12. The method of claim 1 further comprising delaminating the forward osmosis membrane from the solid sheet.

13-17. (canceled)

18. A method for fabrication of a forward osmosis membrane comprising:
casting polymer solution on a solid sheet;
applying a fabric to the cast solid sheet to form a polymer solution infiltrated matrix;
immersing the polymer solution infiltrated matrix into a phase inversion bath to form a support membrane; and
forming a selectivity layer on the support membrane using interfacial polymerization to form the forward osmosis membrane.

19. The method of claim 18, further comprising unrolling the fabric supported by a solid sheet and wherein said immersing the polymer solution infiltrated matrix into a phase inversion bath comprises rolling the polymer solution infiltrated matrix along a path through the phase inversion bath.

20. The method of claim 18, further comprising unrolling the solid sheet from a first roll and unrolling the fabric from a second roll such that the fabric becomes supported by the solid sheet.

21. (canceled)

22. The method of claim 18 further comprising delaminating the support membrane from the solid sheet using an alcohol, wherein the selectivity layer is formed on a side of the support membrane previously in contact with the solid sheet.

23-26. (canceled)

27. The method of claim 18, wherein the casting solution comprises aramid polymers, acrylate-modified poly(vinylidene fluoride) polymers, or combinations thereof.

28-33. (canceled)

34. A system for fabrication of a forward osmosis membrane, the system comprising:
a casting region comprising a chamber housing a casting solution, wherein the casting region is configured to release the casting solution to cast polymer;
a phase inversion bath configured to house a nonsolvent coagulation agent;
an interfacial polymerization region comprising a path through an aqueous solution, an organic solution, and an oven housed therein, wherein the interfacial polymerization region is configured to apply a selectivity layer; and
a roller system positioned to transport the solid sheet through the casting region and phase inversion bath.

35. The system of claim 34 further comprising an alcohol separation bath housing an alcohol, the alcohol separation bath configured to receive a forward osmosis membrane supported by the solid sheet.

36. The system of claim 35 further comprising a delaminating element positioned proximate to the alcohol separation bath, the delaminating element configured to separate the forward osmosis membrane and the solid sheet.

37. The system of claim 36 further comprising a second roller system positioned to transport the solid sheet through the interfacial polymerization region, the alcohol separation bath, and the delaminating element to one or more rolls configured to roll any of the forward osmosis membrane and the solid sheet.

38. The system of claim 34 further comprising a first roll configured to transport the solid sheet to the roller system and a second roll configured to transport the fabric to the roller system.

39-46. (canceled)

47. The system of claim 34, wherein the aqueous solution comprises 1,3 phenylenediamine (MPDA), DABA (diaminobenzoic acid), triethylamine (TEA), sodium dodecylbenzenesulfonate (SDBS), camphor-10-sulfonic acid (CSA), or combinations thereof.
